(19) United States
(12) Patent Application Publication
(10) Pub. No.: US 2010/0133948 A1
(43) Pub. Date: Jun. 3, 2010

(54) CARBON COMMUTATOR AND CARBON BRUSH FOR FUEL PUMP, AND FUEL PUMP HAVING THE CARBON COMMUTATOR AND THE CARBON BRUSH INCORPORATED THEREIN

(75) Inventors: Daisuke Namikoshi, Mitoyo-shi (JP); Shinichi Suzuki, Mitoyo-shi (JP); Naomi Yamashita, Mitoyo-shi (JP); Shigeru Ikuta, Mitoyo-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOTANKAKO CO., LTD., Toyonaka-shi, Osaka (JP)

(21) Appl. No.: 12/594,698

(22) PCT Filed: Apr. 4, 2008
(86) PCT No.: PCT/JP2008/056804

§ 371 Date: Oct. 5, 2009

(30) Foreign Application Priority Data
Apr. 6, 2007 (JP) 2007-100485

(51) Int. Cl. H01R 39/04; H01R 39/26

(52) U.S. Cl. 310/233; 310/253

(57) ABSTRACT

The present invention provides a carbon commutator and a carbon brush for a fuel pump which have excellent slidability and abrasion resistance, and a fuel pump having the carbon commutator and the carbon brush incorporated therein. In the carbon commutator for a fuel pump, at least a contact portion to contact with a brush contains 0.2 to less than 5% by weight of an amorphous carbon. The carbon brush for a fuel pump to contact with and slide on the carbon commutator contains 0.2 to not more than 5% by weight of an amorphous carbon. The fuel pump includes the carbon commutator having the foregoing structure and the carbon brush having the foregoing structure.

### FIELD OF THE INVENTION

The present invention relates to a carbon commutator for a fuel pump, a carbon brush for a fuel pump, and a fuel pump having the carbon commutator and the carbon brush incorporated therein.

### BACKGROUND OF THE INVENTION

A fuel pump has been widely used in internal-combustion engines used in automobiles or other systems. When a brush slides on a contact portion, which is divided into several parts, of a commutator in a motor, an electric current is supplied from a power source to an armature with a coil wound thereon, so as to rotate the armature. The rotation of the armature then causes rotation of an impeller of the pump section, and fuel is thereby sucked from a fuel tank and supplied to an internal-combustion engine.

A commutator is generally made of copper. When the brush to slide on the copper-made contact portion has a low degree of hardness, the brush is easily worn away, and the life of the bush thereby decreases. A possible solution to this problem may be to use a brush made of a carbon material containing amorphous carbons which have a high degree of hardness so as to improve the abrasion resistance of the brush. However, the copper-made contact portion may corrode upon reaction, for example, with oxidized fuel or fuel containing a sulfur component. Moreover, the generation of copper sulfide having an electric conductivity may cause an electrical connection among the separated contact portions. For preventing the reaction between the contact portion and the fuel, for example, a contact portion made of a carbon material as disclosed in Patent Document 1 has been known.

However, the contact portion made of a carbon material has an inferior mechanical strength compared to a copper-made contact portion. When the brush made of the carbon material containing an amorphous carbon slides on the contact portion made of the carbon material, the contact portion is more rapidly worn away. Therefore, this creates a problem in that the life which the contact portion can have before it reaches the wear limit becomes short.

In order to solve this problem, Patent Document 2 discloses a method in which an amorphous carbon is contained in natural graphite in an amount of 5 to 30% by weight. Furthermore, Patent Document 3 discloses a method in which an amorphous carbon is contained in natural graphite in an amount of 30 to 80% by weight.

Meanwhile, a carbon brush designed for a copper-made commutator is normally provided with an abrasive action to remove an arc trace. Therefore, sliding of the brush per se on the copper-made commutator only increases the abrasion loss of the commutator. The Patent Documents have proposed a carbon commutator; however, with regard to a carbon brush to contact with and slide on the carbon commutator, they have merely discussed that the carbon brush is preferably made of the same materials as those of the carbon commutator. In other words, almost no attention has been paid to a carbon brush which hardly abrades the carbon commutator (See, for example, Patent Document 4).

Patent Document 1: U.S. Pat. No. 5,175,463

Patent Document 2: JP-A 10-162923

Patent Document 3: JP-A 2005-57985

Patent Document 4: JP-A 2006-42463

### DISCLOSURE OF THE INVENTION

### Problems to be Solved by the Invention

Each of the conventional technologies focuses on improving the abrasion resistance of either the carbon commutator or the carbon brush only. However, in order to incorporate both the carbon commutator and the carbon brush in a fuel pump, it is necessary to consider the balance between the amount of abrasion of the carbon commutator and that of the carbon brush. For example, as the amorphous carbon content in the carbon commutator increases, the carbon commutator becomes harder and abrasion thereof is reduced. On the other hand, the carbon brush suffers an increased amount of abrasion. Additionally, the increased hardness of the carbon commutator increases friction between the carbon commutator and the carbon brush (deterioration of slidability). In this case, the carbon brush partly has a distance from the contact surface of the carbon commutator. As a result, the partially separated state and a fully contacted state are repeated in extremely short cycles. In such a state, the contact area between the carbon brush and the carbon commutator is practically reduced, resulting in increased contact resistance between the carbon brush and the carbon commutator. This causes a dropping of the contact voltage, which leads to reduction of the driving voltage of the armature. Thus, the efficiency of the pump decreases. For the foregoing reasons, those conventional technologies are not usable especially for a high volume fuel pump.

The same problems occur when the amorphous carbon content in the carbon brush is increased.

There has been a demand for a carbon commutator and a carbon brush having both an appropriate slidability and an appropriate abrasion resistance, which are achievable by controlling the balance between abrasion of the carbon commutator and that of the carbon brush. There has also been a demand for a fuel pump having the carbon commutator and the carbon brush incorporated therein.

The present invention has been devised in view of the foregoing status, and an objective of the present invention is to provide a carbon commutator and a carbon brush for a fuel pump which have excellent slidability and abrasion resistance, and a fuel pump having the carbon commutator and the carbon brush incorporated therein.

### Means for Solving the Problem

In order to attain the objective, the present invention provides a carbon commutator for a fuel pump, in which at least a contact portion to contact with a brush contains 0.2 to less than 5% by weight of an amorphous carbon.

The amorphous carbon content in the carbon commutator is controlled to be in the above range for the following reasons. Namely, the amorphous carbon content of less than 0.2% by weight may result in a carbon commutator with a low level of hardness, leading to excessive abrasion of the carbon commutator. The amorphous carbon content of not less than 5% by weight can reduce the abrasion of the carbon commutator but increases the abrasion of the carbon brush contacting with the carbon commutator, and thereby the life of the carbon brush becomes shorter. Moreover, the amorphous carbon content of not less than 5% by weight excessively increases the hardness of the carbon commutator, which deteriorates the slidability between the brush and the commutator. This increases the contact resistance between the brush and the commutator, and thereby significantly increases the contact voltage drop between them. For the reasons mentioned earlier, by controlling the amorphous carbon content to be in the foregoing range, it is possible to obtain a carbon commutator for a fuel pump, which has excellent slidability and abrasion resistance.

In the carbon commutator for a fuel pump according to the present invention, grain size distribution of the amorphous carbon is preferably in the range of 3 to 70 μm.

The phrase “grain size distribution of the amorphous carbon is in the range of 3 to 70 μm” means that the amorphous carbon is controlled to have a grain size that is within the range of α1 μm (3 μm) to α2 μm (70 μm) by excluding amorphous carbons having a grain size smaller than al μm (3 μm) or amorphous carbons having a grain size larger than α2 μm (70 μm) from amorphous carbons having a grain size within the grain size distribution shown in FIG. 6.

The reason for controlling the grain size of the amorphous carbon to be in the distribution range is as follows. When the grain size is more than 70 μm, the frictional force among the grains becomes large. This makes the carbon commutator less susceptible to abrasion but at the same time have less smoothness. Namely, the abrasion of the carbon commutator is suppressed but the slidability between the carbon commutator and the carbon brush deteriorates, thereby increasing the contact voltage drop. On the other hand, when the grain size is small, friction among the grains is small and good smoothness is imparted. As a result, excellent slidability is achieved between the carbon commutator and the carbon brush and thus the contact voltage drop is reduced. However, since smaller grain size of the amorphous carbon reduces its abrasion-resisting effect, abrasion of the carbon commutator increases. For the reasons mentioned earlier, a carbon commutator having excellent slidability and abrasion resistance can be obtained by controlling the grain size distribution of the amorphous carbon to be in the range of 3 to 70 μm.

The carbon commutator for a fuel pump according to the present invention may optionally contain a solid lubricant such as talc, tungsten disulfide, or molybdenum disulfide.

When the solid lubricant such as talc is contained, the carbon commutator obtains self-lubricating properties and better abrasion resistance.

Another aspect of the present invention is a carbon brush for a fuel pump to contact with and slide on the carbon commutator, the carbon brush containing 0.2 to not more than 5% by weight of an amorphous carbon.

The reason for controlling the amorphous carbon content in the carbon brush to be in the range is the same as that for controlling the amorphous carbon content in the carbon commutator. Namely, when the amorphous carbon content in the carbon brush is less than 0.2% by weight, the hardness of the carbon brush becomes too low, leading to excessive abrasion of the carbon brush. The amorphous carbon content of more than 5% by weight can reduce the abrasion of the carbon brush but increases the abrasion of the carbon commutator contacting with the carbon brush, and the life of the carbon commutator thereby becomes shorter. Additionally, when the amorphous carbon content is more than 5% by weight, the carbon brush becomes too hard, and thus the slidability between the carbon brush and the carbon commutator deteriorates. This causes an increase in the contact resistance between the carbon brush and the carbon commutator, and thus the contact voltage drop between them increases. For the reasons mentioned earlier, a carbon brush for a fuel pump which has excellent slidability and abrasion resistance can be obtained by controlling the amorphous carbon content to be in the foregoing range.

In the carbon brush for a fuel pump according to the present invention, the grain size distribution of the amorphous carbon is preferably in the range of 3 to 70 μm.

The reason for controlling the grain size distribution of the amorphous carbon in the carbon brush to be in the foregoing range is the same as that for controlling the grain size distribution of the amorphous carbon content in the carbon commutator for a fuel pump. Namely, when the grain size is more than 70 μm, the friction force among the grains is increased and the abrasion of the carbon brush is suppressed. At the same time, however, the contact resistance between the carbon commutator and the carbon brush is increased, and thereby the contact voltage drop between them increases. On the other hand, when the grain size is small, the friction force among the grains is reduced. This leads to a smaller contact resistance between the carbon commutator and the carbon brush and a smaller contact voltage drop between them. However, abrasion of the carbon brush is increased. Accordingly, a carbon brush having excellent slidability and abrasion resistance can be achieved by controlling the grain size distribution of the amorphous carbon to be in the range of 3 to 70 μm.

The carbon brush for a fuel pump according to the present invention may optionally contain a solid lubricant such as talc, tungsten disulfide, or molybdenum disulfide.

Similar to the case of the commutator for a fuel pump, this configuration allows the carbon brush to have self-lubricating properties and better abrasion resistance.

Another aspect of the present invention is a fuel pump which is provided with the carbon commutator according to claim 1 and the carbon brush according to claim 4.

This configuration makes it possible to provide a fuel pump having excellent slidability and abrasion resistance.

### EFFECTS OF THE INVENTION

According to the present invention, the carbon commutator for a fuel pump can have an improved slidability and abrasion resistance by controlling the amorphous carbon content to be in the range of 0.2 to less than 5% by weight.

Further, according to the present invention, the carbon brush for a fuel pump can achieve an improved slidability and abrasion resistance by controlling the amorphous carbon content to be in the range of 0.2 to not more than 5% by weight.

Moreover, according to the present invention, the fuel pump in which the carbon commutator for a fuel pump according to the present invention and the carbon brush for a fuel pump according to the present invention are incorporated can have an excellent slidability and abrasion resistance.

### BEST MODE FOR CARRYING OUT THE INVENTION

The following description will discuss the present invention in more detail by citing embodiments of the present invention. The present invention is not limited to those embodiments.

### (Structure of Fuel Pump According to the Present Invention)

FIG. 1 illustrates a cross-sectional view of a fuel pump according to the present invention. As shown in the figure, the fuel pump 20 consists of a pump 21 and a motor 22 as an electromagnetic drive for driving the pump 21. The motor 22 is a direct-current motor provided with a brush, which has a configuration in which a permanent magnet 24 is annularly placed inside a cylindrical housing 23, and an armature 25 is concentrically disposed inside the permanent magnet 24.

The pump 21 consists of a casing body 26, a casing cover 27, an impeller 28 and other parts. The casing body 26 and the casing cover 27 are formed by, for example, aluminum die-cast molding. The casing body 26 is pressure-fixed into one of the ends of the housing 23. A bearing 29 fitted in the center of the casing body rotatably supports a rotation shaft 30 of the armature 25. Fuel suctioned by the pump 21 is pressure-fed into the motor 22. The casing cover 27 in a state of covering the casing body 26 is fixed to one side of the housing 23 using a rivet or similar hardware. A thrust bearing 31 is fixed in the center of the casing cover 27, by which a thrust load of the rotation shaft 30 is supported. An admission port 32 is formed in the casing cover 27 so that fuel in the fuel tank (not shown) is suctioned from the admission port 32 into a pump channel 33 of the pump 21. The casing body 26 and the casing cover 27 constitute one casing, and an impeller 28 is rotatably housed in the casing.

The impeller 28 has blades in the periphery thereof. The fuel suctioned from the admission port 32 to the pump channel 33 by rotation of the impeller 28 is pressure-fed into the motor 22. The armature 25 is rotatably housed in the motor 22, and a coil (not shown) is wound on the periphery of its core 34. The carbon commutator 1 is disposed at the upper side of the armature 25. Electric power is designed to be supplied from a power source (not shown) through an end terminal 36 embedded in a connector 35, a carbon brush (not shown), and the commutator 1 to the coil of the armature 25.

When the coil of the armature 25 is powered on to rotate the armature 25, the impeller 28 starts rotating together with the rotation shaft 30 of the armature 25. The rotation of the impeller 28 makes fuel to be suctioned from the admission port 32 and introduced into the pump channel 33. Then, the fuel, receiving the kinetic energy of the blades of the impeller 28, is pressure-fed from the pump channel 33 into the motor 22. The fuel having been pressure-fed into the motor 22 passes through the vicinity of the armature 25 and is discharged from a fuel discharging port 37.

### (Structure of Carbon Commutator)

The following description will discuss the structure of the carbon commutator 1. As shown in FIGS. 2 and 3, the carbon commutator 1 consists of eight pieces of equiangularly separated segments 2 and a resin supporter 3 for supporting these segments 2. Each segment 2 consists of a contact portion 4 and a copper terminal 5 which is electrically connected to the contact portion 4. Since grooves dividing the segment 2 reach the supporter 3, the segment pieces of the segment 2 are electrically insulated with one another. A nail 5a protrudes from the outer side of the terminal 5 so as to be electrically connected to the coil.

### (Production of Carbon Commutator)

The carbon commutator 1 with the foregoing structure is produced as follows:

First, an end face of the contact portion 2 to be contacted with the terminal 5 is nickel plated, and the nickel-plated face and the terminal 5 are soldered. The terminal 5 is a copper disc provided with the nails 5a in its periphery. The contact portion 2 is formed of a carbon material and a binder, the binder being carbonized. Next, the supporter 3 is formed by molding a resin on the terminal 5. The contact portion 4 and the terminal 5 are formed by cutting and dividing both of them until their sections reach the supporter 3. Thereafter, the nail 5a is fused to the coil to electrically connect the contact portion 4 and the coil.

The carbon material forming the contact portion 2 is a mixture consisting of an amorphous carbon in an amount of 0.2 to less than 5% by weight, and any of natural graphite, artificial graphite, or a combination of natural graphite and artificial graphite in the remaining portion. To provide the contact portion 2, a phenol resin (25% by weight) as a binder is added to the mixture, kneaded and ground until the mixture has an average grain size of not more than 100 μm, and then the ground mixture is molded into a predetermined shape, followed by firing at a temperature of 700° C. to 900° C. under non-oxidizing atmosphere to carbonize the binder. In place of the phenol resin, any of a thermosetting resin other than phenol resins, a coal-tar pitch and a pitch may be used as the binder.

By controlling the amorphous carbon content to be in the range of 0.2 to less than 5% by weight in the previously described manner, a carbon commutator for a fuel pump which has excellent slidability and abrasion resistance can be produced.

The grain size distribution of the amorphous carbon to be contained in the carbon commutator is controlled to be in the range of 3 to 70 μm and desirably in the range of 5 to 50 μm.

The carbon commutator 1 may be further provided with a solid lubricant such as talc, MoS₂ (molybdenum disulfide) or WS₂ (tungsten disulfide) to achieve self-lubricating properties. The amount of the solid lubricant to be added is preferably 0.2 to 5% by weight.

### (Structure and Production Method of Carbon Brush)

An example of the shape of a carbon brush 11 according to the present invention is shown in FIG. 4. A lead 12 is connected to a portion of the carbon brush 11. The carbon brush 11 consists of a carbon material and a binder, the binder being carbonized.

A specific method for producing the carbon brush 11 is as follows: The carbon material forming the carbon brush 11 is a mixture consisting of an amorphous carbon in an amount of 0.2 to not more than 5% by weight, and any of natural graphite, artificial graphite or a combination of natural graphite and artificial graphite in the remaining portion; for the carbon brush 11, a phenol resin as a binder is added to the mixture in an amount of 20% by weight, followed by mixing, kneading and grinding of the mixture until the mixture has an average grain size of not more than 100 μm; and the ground mixture is molded into a desired shape and then fired at 700° C. to 900° C. under non-oxidizing atmosphere to carbonize the binder. In place of the phenol resin, any of a thermosetting resin other than phenol resins, a coal-tar pitch or a pitch may be used as the binder.

By controlling the amorphous carbon content to be in the range of 0.2 to less than 5% by weight, a carbon brush for a fuel pump which has excellent slidability and abrasion resistance can be produced.

The grain size distribution of the amorphous carbon to be contained in the carbon brush is controlled to be in the range of 3 to 70 μm and desirably in the range of 5 to 50 μm. Further, the carbon brush 11 may also be provided with a solid lubricant such as talc, MoS₂ (molybdenum disulfide) or WS₂ (tungsten disulfide) to achieve self-lubricating properties. The amount of the solid lubricant to be added is preferably 0.2 to 5% by weight.

### EXAMPLES

The following description will discuss the present invention in more detail by showing Examples; however, the present invention is not limited to those examples.

### (A1) Relations Between the Amount of Amorphous Carbon in Carbon Brush and Dynamic Characteristics

### Example 1

Amorphous carbon in an amount of 0.2% by weight and natural graphite in an amount of 99.8% by weight were mixed with 20% by weight of a phenol resin and kneaded. Thereafter, the resulting product was dried, ground so as to achieve an average grain size of not more than 100 μm, and then molded into the shape shown in FIG. 4. The molded body was fired at a temperature of 1000° C. or lower, to obtain a carbon brush. The carbon brush was mounted on a test device shown in FIG. 5 and the abrasion rate of the carbon brush, the abrasion rate of a commutator and a contact voltage drop were measured. Table 1 shows the results. The commutator 1 used in the test device shown in FIG. 5 was a commutator made of 3% by weight of amorphous carbon and natural graphite in the remaining portion.

TABLE 1

| | Amor- | | Commutator | Brush | Contact |
|---|---|---|---|---|---|
| | phous | Natural | abrasion | abrasion | voltage |
| | carbon | graphite | rate (mm/ | rate (mm/ | drop (V/1 |
| | (Wt %) | (Wt %) | 1000 h) | 1000 h) | piece) |
| Comparative | 0 | 100 | 0.2 | 1.2 | 1.7 |
| Example 1 | | | | | |
| Example 1 | 0.2 | 99.8 | 0.2 | 0.7 | 1.7 |
| Example 2 | 1 | 99 | 0.3 | 0.6 | 1.7 |
| Example 3 | 3 | 97 | 0.4 | 0.5 | 1.8 |
| Example 4 | 5 | 95 | 0.5 | 0.4 | 1.9 |
| Comparative | 6 | 94 | 0.7 | 0.4 | 2.2 |
| Example 2 | | | | | |
| Comparative | 10 | 90 | 0.9 | 0.3 | 2.3 |
| Example 3 | | | | | |

Note:
A commutator made of amorphous carbon in an amount of 3% by weight and natural graphite in the remaining portion was used.

The test device shown in FIG. 5 is provided with a motor 13 having the commutator 1 on the tip, the carbon brush 11 to contact with the commutator 1, and a spring 12 to press the carbon brush 11 to the commutator 1. The abrasion rate of the brush was measured in an atmosphere of a petroleum mineral oil 14 under the condition as follows, on the assumption that the brush was actually used as a carbon brush for a fuel pump.

Commutator: φ 20 (mm)

Rotation: 10000 (min⁻¹)

Circumferential velocity: 10 (m/s)

Electric current: D.C. 10 (A)

### Example 2

A carbon brush was produced and tested in the same manner as in Example 1, except that the amorphous carbon content and the natural graphite content were changed to 1% by weight and 99% by weight, respectively. Table 1 shows the result.

### Example 3

A carbon brush was produced and tested in the same manner as in Example 1, except that the amorphous carbon content and the natural graphite content were changed to 3% by weight and 97% by weight, respectively. Table 1 shows the result.

### Example 4

A carbon brush was produced and tested in the same manner as in Example 1, except that the amorphous carbon content and the natural graphite content were changed to 5% by weight and 95% by weight, respectively. Table 1 shows the result.

### Comparative Example 1

A carbon brush was produced and tested in the same manner as in Example 1, except that 100% by weight of the natural graphite was used. Table 1 shows the result.

### Comparative Example 2

A carbon brush was produced and tested in the same manner as in Example 1, except that the amorphous carbon content and the natural graphite content were changed to 6% by weight and 94% by weight, respectively. Table 1 shows the result.

### Comparative Example 3)

A carbon brush was produced and tested in the same manner as in Example 1, except that the amorphous carbon content and the natural graphite content were changed to 10% by weight and 90% by weight, respectively. Table 1 shows the result.

### (Examination of Test Results)

As is evident from Table 1, Examples 1 to 4 are excellent in terms of any of the measured values, i.e. the abrasion rate of the commutator, the abrasion rate of the brush, and the contact voltage drop.

On the other hand, the abrasion rate of the brush is high in Comparative Example 1. The results indicate that the carbon brush obtained in Comparative Example 1 has a short life and thus is inappropriate for use. This result may be because the amorphous carbon content of less than 0.2% by weight produced the carbon brush with a low degree of hardness, and thus the abrasion of the carbon brush increased.

In Comparative Examples 2 and 3, although the abrasion rate of the brush was favorable, the abrasion rate of the commutator and the contact voltage drop were too high. The carbon brushes obtained in Comparative Examples 2 and 3 may reduce the efficiency of a fuel pump, and thus they are inappropriate for use. This result may be because, when the amorphous carbon content exceeded 5% by weight in the carbon brush, abrasion of the carbon brush decreased, but the abrasion of the carbon commutator contacting with the carbon brush increased too much, leading to a shorter life of the carbon commutator. In addition, when the amorphous carbon content in the carbon brush was not less than 5% by weight, the hardness of the carbon brush excessively increases, thereby deteriorating the slidability between the carbon brush and the commutator. Supposedly, this caused the increase of the contact resistance between the brush and the commutator so that the contact voltage drop between them increased.

### (A2) Relations Between the Amount of Amorphous Carbon in Carbon Commutator and Dynamic Characteristics

### Example 5

Amorphous carbon in an amount of 0.2% by weight and natural graphite in an amount of 99.8% by weight were mixed with 25% by weight of a phenol resin and kneaded. Thereafter, the resulting product was dried, ground so as to achieve an average grain size of not more than 100 μm, and then molded into the shape shown in FIGS. 2 and 3. The molded body was fired at a temperature of 1000° C. or lower, and thereby a carbon commutator was produced. The carbon commutator was tested in the same manner as in Example 1. Table 2 shows the results. The carbon brush used in the test was a carbon brush made of amorphous carbon in an amount of 3% by weight and natural graphite in the remaining portion.

TABLE 2

| | Amor- | | Commutator | Brush | Contact |
|---|---|---|---|---|---|
| | phous | Natural | abrasion | abrasion | voltage |
| | carbon | graphite | rate (mm/ | rate (mm/ | drop (V/1 |
| | (Wt %) | (Wt %) | 1000 h) | 1000 h) | piece) |
| Comparative | 0 | 100 | 1.0 | 0.3 | 1.7 |
| Example 4 | | | | | |
| Example 5 | 0.2 | 99.8 | 0.6 | 0.4 | 1.7 |
| Example 6 | 1 | 99 | 0.5 | 0.4 | 1.7 |
| Example 7 | 3 | 97 | 0.4 | 0.5 | 1.8 |
| Example 8 | 4.8 | 95.2 | 0.4 | 0.6 | 1.8 |
| Comparative | 6 | 94 | 0.3 | 0.9 | 1.9 |
| Example 5 | | | | | |
| Comparative | 10 | 90 | 0.3 | 1.1 | 2.1 |
| Example 6 | | | | | |

Note:
A brush made of 3% by weight of amorphous carbon and natural graphite in the remaining portion was used.

### Example 6

A carbon commutator was produced and tested in the same manner as in Example 5, except that the amorphous carbon content and the natural graphite content were changed to 1% by weight and 99% by weight, respectively. Table 2 shows the result.

### Example 7

A carbon commutator was produced and tested in the same manner as in Example 5, except that the amorphous carbon content and the natural graphite content were changed to 3% by weight and 97% by weight, respectively. Table 2 shows the result.

### Example 8

A carbon commutator was produced and tested in the same manner as in Example 5, except that the amorphous carbon content and the natural graphite content were changed to 4.8% by weight and 95.2% by weight, respectively. Table 2 shows the result.

### Comparative Example 4

A carbon commutator was produced and tested in the same manner as in Example 5, except that 100% by weight of the natural graphite was used. Table 2 shows the result.

### Comparative Example 5

A carbon commutator was produced and tested in the same manner as in Example 5, except that the amorphous carbon content and the natural graphite content were changed to 6% by weight and 94% by weight, respectively. Table 2 shows the result.

### Comparative Example 6

A carbon commutator was produced and tested in the same manner as in Example 5, except that the amorphous carbon content and the natural graphite content were changed to 10% by weight and 90% by weight, respectively. Table 2 shows the result.

### (Examination of Test Results)

As is evident from Table 2, Examples 5 to 8 are excellent in terms of any of the measured properties, i.e. the abrasion rate of the commutator, the abrasion rate of the brush, and the contact voltage drop.

On the other hand, the abrasion rate of the commutator is high in Comparative Example 4. The result indicates that the carbon commutator obtainable in Comparative Example 4 has a short life and thus is inappropriate for use. This result may be because the amorphous carbon content of less than 0.2% by weight produced the carbon commutator with a low degree of hardness, and thus the abrasion of the carbon commutator increased.

In Comparative Example 5, although the abrasion rate of the commutator was favorable, the contact voltage drop was as high as 1.9V and the abrasion rate of the brush was too high. This result indicates that the carbon brush has a short life, and thus the carbon commutator is not appropriate for use. In Comparative Example 6, the abrasion rate of the carbon brush was too high and further the contact voltage drop was too high. This may lead to a short life of the brush and reduction of the efficiency of a fuel pump. Therefore, the carbon commutator is inappropriate for use. This result may be because, when the amorphous carbon content exceeded 5% by weight in the carbon commutator, abrasion of the commutator decreased, but the abrasion of the carbon brush contacting with the carbon commutator increased too much, leading to a shorter life of the carbon brush. In addition, when the amorphous carbon content in the carbon commutator was not less than 5% by weight, the hardness of the carbon commutator excessively increased, and thereby the slidability between the brush and the commutator deteriorated. Supposedly, this caused the increase of the contact resistance between the brush and the commutator so that the contact voltage drop between them increased.

### (A3) Relations Between the Amount of Talc in Carbon Brush and Dynamic Characteristics

### Example 9

Amorphous carbon in an amount of 3% by weight and natural graphite in an amount of 97% by weight were mixed with 0.2% by weight of talc and 20% by weight of a phenol resin and kneaded. Thereafter, the resulting product was dried, ground so as to achieve an average grain size of not more than 100 μm, and then molded into the shape shown in FIG. 4. The molded body was fired at a temperature of 1000° C. or lower, and thereby a carbon brush was produced. The carbon brush was tested in the same manner as in Example 1. Table 3 shows the results. The carbon commutator used in the test was a carbon commutator made of amorphous carbon in an amount of 3% by weight and natural graphite in the remaining portion.

TABLE 3

| | | Commutator | Brush | Contact |
|---|---|---|---|---|
| | Talc | abrasion rate | abrasion rate | voltage drop |
| | (Wt %) | (mm/1000 h) | (mm/1000 h) | (v/1 piece) |
| Example 3 | 0 | 0.4 | 0.5 | 1.8 |
| Example 9 | 0.2 | 0.3 | 0.4 | 1.7 |
| Example 10 | 1 | 0.3 | 0.3 | 1.6 |
| Example 11 | 5 | 0.4 | 0.3 | 1.7 |
| Example 12 | 6 | 0.4 | 0.5 | 1.8 |
| Example 13 | 10 | 0.5 | 0.6 | 1.9 |

Note:
A commutator made of 3% by weight of amorphous carbon and natural graphite in the remaining portion was used.

### Example 10

A carbon brush was produced and tested in the same manner as in Example 9, except that the talc content was changed to 1% by weight. Table 3 shows the result.

### Example 11

A carbon brush was produced and tested in the same manner as in Example 9, except that the talc content was changed to 5% by weight. Table 3 shows the result.

### Example 12

A carbon brush was produced and tested in the same manner as in Example 9, except that the talc content was changed to 6% by weight. Table 3 shows the result.

### Example 13

A carbon brush was produced and tested in the same manner as in Example 9, except that the talc content was changed to 10% by weight. Table 3 shows the result.

It is to be noted that Table 3 also includes the result of Example 3 shown in Table 1. Namely, Table 3 shows the result obtained when a carbon brush was produced and the tests were performed on the brush in the same manner as in Example 9, except that the talc content was changed to 0% by weight.

### (Examination of Test Results)

As is evident from Table 3, the contact voltage drops in Examples 9 to 11 are smaller than that in Example 3. Example 12 and Example 3 show the same contact voltage drop, and Example 13 shows a larger contact drop than that in Example 3. This result may be because, when the carbon brush contained 0.2 to 5% by weight of talc, the carbon brush obtained self-lubricating properties, and thereby the slidability and abrasion resistance thereof further improved.

The reason why more than 5% by weight talc content deteriorated the slidability and abrasion resistance may be because intervention of talc abrasion powders increased the contact resistance, and thereby the slidability was deteriorated.

### (A4) Relations Between the Amount of Talc in Carbon Commutator and Dynamic Characteristics

### Example 14

Amorphous carbon in an amount of 3% by weight and natural graphite in an amount of 97% by weight were mixed with 0.2% by weight of talc and 25% by weight of a phenol resin and kneaded. Thereafter, the resulting product was dried, ground so as to achieve an average grain size of not more than 100 μm, and then molded into the shape shown in FIGS. 2 and 3. The molded body was fired at a temperature of 1000° C. or lower, and thereby a carbon commutator was produced. The carbon commutator was tested in the same manner as in Example 1. Table 4 shows the results. The carbon brush used in the test was a carbon brush made of amorphous carbon in an amount of 3% by weight and natural graphite in the remaining portion.

TABLE 4

| | | Commutator | Brush | Contact |
|---|---|---|---|---|
| | talc | abrasion rate | abrasion rate | voltage drop |
| | (Wt %) | (mm/1000 h) | (mm/1000 h) | (v/1 piece) |
| Example 7 | 0 | 0.4 | 0.5 | 1.8 |
| Example 14 | 0.2 | 0.3 | 0.4 | 1.7 |
| Example 15 | 1 | 0.3 | 0.3 | 1.7 |
| Example 16 | 5 | 0.3 | 0.4 | 1.7 |
| Example 17 | 6 | 0.5 | 0.5 | 1.8 |
| Example 18 | 10 | 0.6 | 0.6 | 1.9 |

Note:
A brush made of 3% by weight of amorphous carbon and natural graphite in the remaining portion was used.

### Example 15

A carbon commutator was produced and tested in the same manner as in Example 14, except that the talc content was changed to 1% by weight. Table 4 shows the result.

### Example 16

A carbon commutator was produced and tested in the same manner as in Example 14, except that the talc content was changed to 5% by weight. Table 4 shows the result.

### Example 17

A carbon commutator was produced and tested in the same manner as in Example 14, except that the talc content was changed to 6% by weight. Table 4 shows the result.

### Example 18

A carbon commutator was produced and tested in the same manner as in Example 14, except that the talc content was changed to 10% by weight. Table 4 shows the result.

It is to be noted that Table 4 also includes the result of Example 7 shown in Table 2. Namely, Table 4 shows the result obtained when a carbon commutator was produced and the tests were performed on the commutator in the same manner as in Example 14, except that the talc content was changed to 0% by weight.

### (Examination of Test Results)

As is evident from Table 4, the contact voltage drops in Examples 14 to 16 are smaller than that in Example 7. Example 17 and Example 7 show the same contact voltage drop, and Example 18 shows a larger contact drop than that in Example 7. This result may be because, when the carbon commutator contained 0.2 to 5% by weight of talc, the carbon commutator obtained self-lubricating properties so that the slidability and abrasion resistance thereof further improved.

The reason why more than 5% by weight of talc content deteriorated the slidability and abrasion resistance may be because intervention of talc abrasion powders increased the contact resistance, and thereby the slidability was deteriorated.

### (A5) Relations Between Grain Size Control of Amorphous Carbon in Carbon Brush and Dynamic Characteristics

### Example 19

Amorphous carbon having a grain size distribution of 3 to 70 μm in an amount of 3% by weight and natural graphite in an amount of 97% by weight were mixed with 20% by weight of a phenol resin and kneaded. Thereafter, the resulting product was dried, ground so as to achieve an average grain size of not more than 100 μm, and then molded into the shape shown in FIG. 4. The molded body was fired at a temperature of 1000° C. or lower, and thereby a carbon brush was produced. The carbon brush was tested in the same manner as in Example 1. Table 5 shows the results. The carbon commutator used in the test was a carbon commutator made of amorphous carbon in an amount of 3% by weight and natural graphite in the remaining portion.

TABLE 5

| | Grain size | | | |
|---|---|---|---|---|
| | distribution | Commutator | Brush | Contact |
| | of amorphous | abrasion rate | abrasion rate | voltage drop |
| | carbon (μm) | (mm/1000 h) | (mm/1000 h) | (v/1 piece) |
| Example 19 | 3-70 | 0.3 | 0.4 | 1.7 |
| Example 20 | 5-50 | 0.3 | 0.3 | 1.7 |
| Example 21 | 10-30 | 0.3 | 0.3 | 1.7 |
| Example 22 | 0.5-100 | 0.4 | 0.5 | 1.8 |
| Example 23 | 2-80 | 0.4 | 0.5 | 1.8 |

Note:
A commutator made of 3% by weight of amorphous carbon and natural graphite in the remaining portion was used.

### Example 20

A carbon brush was produced in the same manner and with the same formulation as in Example 19 and the carbon brush was tested in the same manner as in Example 19, except that the grain size distribution of the amorphous carbon was changed to a range of 5 to 50 μm. Table 5 shows the result.

### Example 21

A carbon brush was produced in the same manner and with the same formulation as in Example 19 and the carbon brush was tested in the same manner as in Example 19, except that the grain size distribution of the amorphous carbon was changed to a range of 10 to 30 μm. Table 5 shows the result.

### Example 22

A carbon brush was produced in the same manner and with the same formulation as in Example 19 and the carbon brush was tested in the same manner as in Example 19, except that the grain size distribution of the amorphous carbon was changed to a range of 0.5 to 100 μm. Table 5 shows the result.

### Example 23

A carbon brush was produced in the same manner and with the same formulation as in Example 19 and the carbon brush was tested in the same manner as in Example 19, except that the grain size distribution of the amorphous carbon was changed to a range of 2 to 80 μm. Table 5 shows the result.

### (Examination of Test Results)

As is evident from Table 5, the contact voltage drops in Examples 19 to 21 are smaller than those in Examples 22 and 23. The reason for this may be as follows: In Examples 22 and 23, as the maximum grain size was more than 70 μm, the friction between the carbon brush and the carbon commutator increased. The slidability between the carbon commutator and the carbon brush thus deteriorated so that the contact voltage drop increased. Meanwhile, in Examples 22 and 23, although the minimum grain size of less than 3 μm led to low friction between the carbon brush and the carbon commutator, the amount of the increase in the friction among the grains derived from the maximum grain size of more than 70 μm was much larger than the amount of the decrease in the friction among the grains derived from the minimum grain size of less than 3 μm. As a result, the friction between the carbon commutator and the carbon brush increased to deteriorate the slidability between the carbon commutator and the carbon brush, thereby increasing the contact voltage drop.

### (A6) Relations Between Grain Size Control of Amorphous Carbon in Carbon Commutator and Dynamic Characteristics

### Example 24

Amorphous carbon having a grain size distribution of 3 to 70 μm in an amount of 3% by weight and natural graphite in an amount of 97% by weight, were mixed with 25% by weight of a phenol resin and kneaded. Thereafter, the resulting product was dried, ground so as to achieve an average grain size of not more than 100 μm, and then molded into the shape shown in FIGS. 2 and 3. The molded body was fired at a temperature of 1000° C. or lower, and thereby a carbon commutator was produced. The carbon commutator was tested in the same manner as in Example 1. Table 6 shows the results. The carbon brush used in the test was a carbon brush made of 3% by weight of amorphous carbon and natural graphite in the remaining portion.

TABLE 6

| | Grain size | | | |
|---|---|---|---|---|
| | distribution | Commutator | Brush | Contact |
| | of amorphous | abrasion rate | abrasion rate | voltage drop |
| | carbon (μm) | (mm/1000 h) | (mm/1000 h) | (v/1 piece) |
| Example 24 | 3-70 | 0.3 | 0.4 | 1.7 |
| Example 25 | 5-50 | 0.3 | 0.3 | 1.7 |
| Example 26 | 10-30 | 0.3 | 0.3 | 1.7 |
| Example 27 | 0.5-100 | 0.4 | 0.5 | 1.8 |
| Example 28 | 2-80 | 0.4 | 0.5 | 1.8 |

Note:
A brush made of 3% by weight of amorphous carbon and natural graphite in the remaining portion was used.

### Example 25

A carbon commutator was produced in the same manner and with the same formulation as in Example 24 and the carbon commutator was tested in the same manner as in Example 24, except that the grain size distribution of the amorphous carbon was changed to a range of 5 to 50 μm. Table 6 shows the result.

### Example 26

A carbon commutator was produced in the same manner and with the same formulation as in Example 24 and the carbon commutator was tested in the same manner as in Example 24, except that the grain size distribution of the amorphous carbon was changed to a range of 10 to 30 μm. Table 6 shows the result.

### Example 27

A carbon commutator was produced in the same manner and with the same formulation as in Example 24 and the carbon commutator was tested in the same manner as in Example 24, except that the grain size distribution of the amorphous carbon was changed to a range of 0.5 to 100 μm. Table 6 shows the result.

### Example 28

A carbon commutator was produced in the same manner and with the same formulation as in Example 24 and the carbon commutator was tested in the same manner as in Example 24, except that the grain size distribution of the amorphous carbon was changed to a range of 2 to 80 μm. Table 6 shows the result.

### (Examination of Text Results)

As is evident from Table 6, the contact voltage drops in Examples 24 to 26 were smaller than those in Examples 27 and 28. The reason for this may be as follows: In Examples 27 and 28, as the maximum grain size was more than 70 μm, the friction between the carbon brush and the carbon commutator increased. The slidability and contacting property between the carbon commutator and the carbon brush thus deteriorated so that the contact voltage drop increased. Meanwhile, in Examples 27 and 28, although the minimum grain size of less than 3 μm led to low friction among the grains, the amount of increase in the friction between the carbon commutator and the carbon brush derived from the maximum grain size of more than 70 μm was much larger than the amount of decrease in the friction between the carbon commutator and the carbon brush derived from the minimum grain size of less than 3 μm. As a result, the friction among the grains increases to deteriorate the slidability between the carbon commutator and the carbon brush, thereby causing the large contact voltage drop.

### INDUSTRIAL APPLICABILITY

The present invention is applicable to a carbon commutator for a fuel pump of internal combustion engines, a carbon brush for a fuel pump of internal combustion engines, a fuel pump of internal combustion engines, and other applications.

### BRIEF EXPLANATION OF THE DRAWINGS

FIG. 1 illustrates a cross-sectional view of the fuel pump according to the present invention.

FIG. 2 illustrates a view of one example of the carbon commutator according to the present invention.

FIG. 3 is an A-A line cross-sectional view of FIG. 2.

FIG. 4 illustrates a perspective view of one example of the carbon brush according to the present invention.

FIG. 5 illustrates a schematic view of an apparatus for testing the carbon commutator according to the present invention and the carbon brush according to the present invention.

FIG. 6 illustrates a view of a grain size distribution of amorphous carbons.

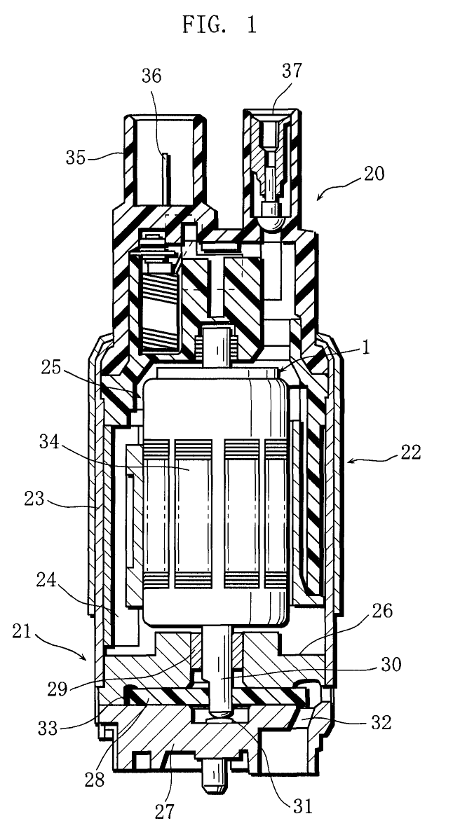

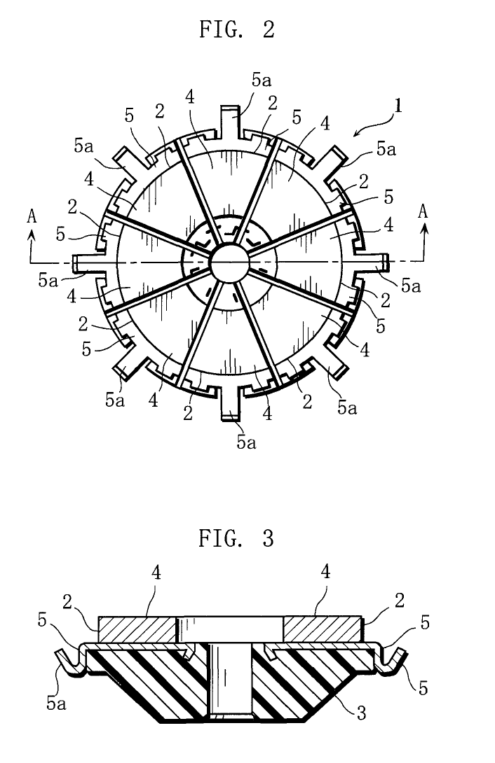

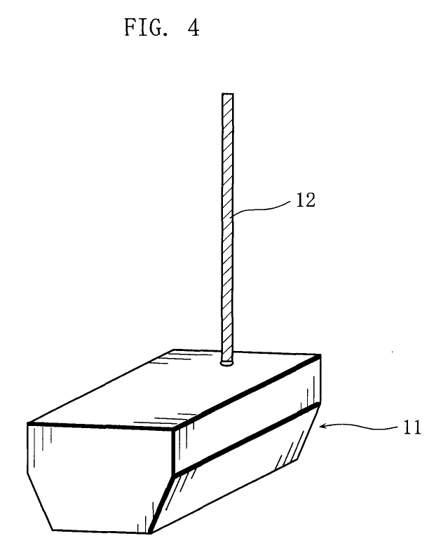

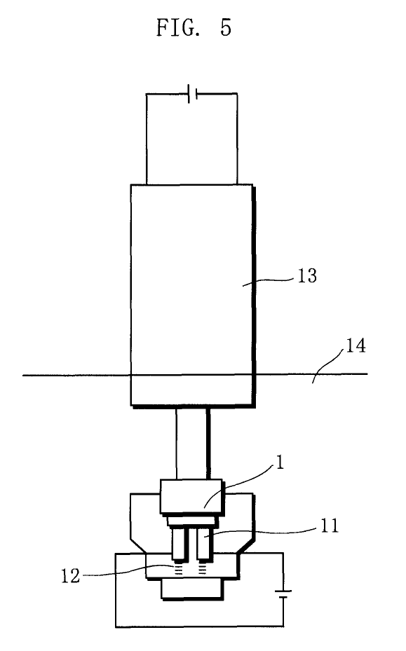

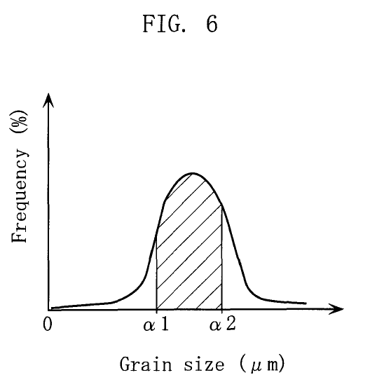

### EXPLANATION OF SYMBOLS

1. Carbon commutator
2. Segment
3. Supporter
4. Contact portion
5. Terminal
11. Carbon brush
20. Fuel pump

1. A carbon commutator for a fuel pump, wherein at least a contact portion to contact with a brush contains 0.2 to less than 5% by weight of an amorphous carbon.

2. The carbon commutator for a fuel pump according to claim 1, wherein a grain size distribution of the amorphous carbon is in a range of 3 to 70 μm.

3. The carbon commutator for a fuel pump according to claim 1, further comprising a solid lubricant.

4. A carbon brush for a fuel pump to contact with and slide on a carbon commutator, wherein the carbon brush contains 0.2 to not more than 5% by weight of an amorphous carbon.

5. The carbon brush for a fuel pump according to claim 4, wherein a grain size distribution of the amorphous carbon is in a range of 3 to 70 μm.

6. The carbon brush for a fuel pump according to claim 4, further comprising a solid lubricant.

7. A fuel pump comprising a carbon commutator, wherein at least a contact portion to contact with a brush contains 0.2 to less than 5% by weight of an amorphous carbon and the carbon brush according to claim 4.
